(19) United States
(12) Patent Application Publication
(10) Pub. No.: US 2026/0307510 A1
(43) Pub. Date: Oct. 8, 2026

(54) BATTERY MOUNTING STRUCTURE FOR VEHICLE

(71) Applicants: Hyundai Motor Company, Seoul (KR); Kia Corporation, Seoul (KR)

(72) Inventors: Sung Woong HA, Hwaseong-si (KR); Yun Bae Chun, Hwaseong-si (KR); Kang Hyeok KWON, Hwaseong-si (KR); Jae Woo Joung, Hwaseong-si (KR); Chulhee Heo, Hwaseong-si (KR); Jiae Yong, Hwaseong-si (KR)

(21) Appl. No.: 19/352,195

(22) Filed: Oct. 7, 2025

(30) Foreign Application Priority Data
Apr. 2, 2025 (KR) 10-2025-0042544
Jul. 7, 2025 (KR) 10-2025-0090681

(51) Int. Cl. B60L 50/64; B60R 16/04; H01M 50/249; H01M 50/262

(52) U.S. Cl. CPC B60L 50/64; B60R 16/04; H01M 50/249; H01M 50/262; H01M 2220/20

(57) ABSTRACT

A battery mounting structure is disclosed. The battery mounting structure according to the disclosed exemplary embodiment is configured to mount a battery assembly on an underbody of a vehicle body and includes an integrated battery mounting section provided on the underbody and including a battery mounting portion and a dummy portion partitioned along the front-rear direction of the vehicle body and a strut assembly mounted on the dummy portion.

### CROSS-REFERENCE TO RELATED APPLICATIONS

This application claims priority to and the benefit of Korean Patent Application No. 10-2025-0042544 filed with the Korean Intellectual Property Office on April 2, 2025, and Korean Patent Application No. 10-2025-0090681 filed with the Korean Intellectual Property Office on July 7, 2025, the entire contents of which are incorporated herein by reference.

### TECHNICAL FIELD

The present disclosure relates to a vehicle body, and more particularly, to a battery mounting structure applicable to a production of various vehicle bodies.

### BACKGROUND

Recently, the vehicle industry has introduced a new concept of future mobility visions for realizing a human-centered dynamic future city. One of these future mobility solutions is a PBV (purpose-built vehicle) as a purpose-based mobility.

An example of the PBV is an eco-friendly mobility vehicle based on an electric vehicle (EV). These PBVs provide various customized services to passengers during a period in which they travel to their destination on the ground.

The PBVs may be configured in various shapes and sizes depending on the user's use case. For example, the PBVs may be used as hailing or delivery type vehicles.

The body of such a PBV may be composed of an underbody (also called a chassis frame, a rolling chassis, or a skateboard by those skilled in the art) and an upper body assembled to the underbody.

Here, a battery assembly may be mounted in the predetermined battery mounting area of the underbody. The specifications of these battery assemblies (e.g., the different case sizes and battery capacities) may vary depending on the use case of the PBV.

Accordingly, as an example, the battery case manufactured in a single size may be provided to correspond to the various specifications of the battery assembly, and the arrangement of the battery cells mounted inside the battery case may be changed.

However, in the above case, design changes of the battery assembly are required for the air-tightness and collision response of the battery case.

Furthermore, as another example, the battery assemblies individually manufactured according to the specifications may be mounted on the underbody of the PBV.

However, in the above case, the underbody of the PBV may be manufactured with the different body types depending on the specifications of the battery assembly. Accordingly, if the structure of the underbody is developed separately according to the specifications of the battery assembly, the development period, manufacturing cost, and investment cost may increase.

The above information disclosed in this Background section is only for enhancement of understanding of the background of the disclosure and therefore it may contain information that does not form the prior art that is already known in this country to a person of ordinary skill in the art.

### SUMMARY

Embodiments provide a battery mounting structure that allows battery assemblies of different specifications to be mounted without structural changes to the underbody.

A battery mounting structure according to the disclosed embodiment may be configured to mount a battery assembly on an underbody of a vehicle body, and may include an integrated battery mounting section provided on the underbody and including a battery mounting portion and a dummy portion partitioned along the front-rear direction of the vehicle body; and a strut assembly mounted on the dummy portion.

Also, in the battery mounting structure according to the disclosed embodiment, a battery assembly of a first specification may be mounted in the integrated battery mounting section.

Also, in the battery mounting structure according to the disclosed embodiment, a battery assembly of a second specification having a smaller size than the battery assembly of the first specification mounted in the integrated battery mounting section may be mounted in the battery mounting portion.

Also, in the battery mounting structure according to the disclosed embodiment, the strut assembly may be fastened to the battery assembly of the second specification mounted in the battery mounting portion.

The battery mounting structure according to the disclosed embodiment may further include a first mounting part provided on the edge of the battery mounting portion, a second mounting part provided on the edge of the above dummy portion, and a third mounting part and a fourth mounting part provided at the boundary point of the battery mounting portion and the above dummy portion.

Also, in the battery mounting structure according to the disclosed embodiment, the battery assembly of the first specification may be mounted on the first mounting part and the second mounting part.

Also, in the battery mounting structure according to the disclosed embodiment, a battery assembly of a second specification having a smaller size than the battery assembly of the first specification may be mounted on the first mounting part and the third mounting part

Also, in the battery mounting structure according to the disclosed embodiment, the first mounting part may be provided as a first common mounting part for mounting the battery assembly of the first specification or the battery assembly of the second specification.

Also, in the battery mounting structure according to the disclosed embodiment, the strut assembly may be mounted on the second mounting part,

Also, in the battery mounting structure according to the disclosed embodiment, the battery assembly of the second specification and the strut assembly may be mounted on the fourth mounting part, and

Also, in the battery mounting structure according to the disclosed embodiment, the second mounting part may be provided as second common mounting parts for mounting the battery assembly of the first specification or the strut assembly.

Also, in the battery mounting structure according to the disclosed embodiment, the strut assembly may be manufactured of a plurality of aluminum extruded members having a plurality of closed sections formed internally by inner bulkheads.

Also, in the battery mounting structure according to the disclosed embodiment, the strut assembly may include a body support unit placed in the dummy potion, at least one side mounting member connected each to both sides of the body support unit in the vehicle width direction and combined with an under side part provided in the under body, at least one battery mounting member connected to the front part of the body support unit and fastened to the battery assembly mounted in the battery mounting portion, and at least one rear mounting member connected to the rear part of the body support unit and fastened with an under rear part provided in the under body.

Also, in the battery mounting structure according to the disclosed embodiment, the body support unit may include a pair of cross members arranged along the width direction of the dummy portion, and a side member connected to both ends of the cross member along the front-rear direction of the vehicle body.

Also, in the battery mounting structure according to the disclosed embodiment, at least one battery mounting member may be coupled to a cross member located at the front,

Also, in the battery mounting structure according to the disclosed embodiment, at least one rear mounting member may be coupled to a cross member located at the rear.

Also, in the battery mounting structure according to the disclosed embodiment, at least one side mounting member may be coupled to the side members.

Also, in the battery mounting structure according to the disclosed embodiment, the body support unit may further include at least one diagonal reinforcing member diagonally connected to the cross member and the side member.

Also, in the battery mounting structure according to the disclosed embodiment, at least one battery mounting member may include a pin hole into which a reference pin provided on a battery mounting jig is inserted, and bolt fastening holes formed on each side with the pin hole in between.

Also, in the battery mounting structure according to the disclosed embodiment, at least one side mounting member and at least one rear mounting member may be coupled to the second mounting parts.

Also, in the battery mounting structure according to the disclosed embodiment, the battery assembly of the specification and at least one battery mounting member may be coupled to the fourth mounting parts.

Also, in the battery mounting structure according to the disclosed embodiment, the strut assembly may further include an undercover coupled to the body support unit.

Accordingly, according to the battery mounting structure according to the disclosed embodiment, the expandability of the body according to the traveling driving performance, the purpose of the use, and the use case of the PBV may be secured, and the platform performance of the underbody may be secured.

In addition, according to the battery mounting structure according to the disclosed embodiment, a combined production according to the specifications of the body is possible, a body development period and an investment cost may be reduced, and the lower rigidity and torsional rigidity of the body may be strengthened.

Further, effects that can be obtained or expected from exemplary embodiments of the present disclosure are directly or suggestively described in the following detailed description. That is, various effects expected from exemplary embodiments of the present disclosure will be described in the following detailed description.

### BRIEF DESCRIPTION OF THE DRAWINGS

The drawings are provided for reference in describing embodiments of the present disclosure, and the spirit of the present disclosure should not be construed only by the accompanying drawings.

FIG. 1 is a bottom view of a body illustrating a battery mounting structure according to a disclosed embodiment;

FIG. 2 is a bottom view of an underbody applied to a battery mounting structure according to a disclosed embodiment;

FIG. 3 is a perspective view illustrating a strut assembly applied to a battery mounting structure according to a disclosed embodiment;

FIG. 4 is a plan view illustrating a strut assembly applied to a battery mounting structure according to a disclosed embodiment;

FIG. 5 is a view illustrating an aluminum extrusion member shape of a strut assembly applied to a battery mounting structure according to a disclosed embodiment;

FIG. 6 is a view illustrating a side mounting member of a strut assembly applied to a battery mounting structure according to a disclosed embodiment;

FIGS. 7 and 8 are views illustrating a battery mounting member of a strut assembly applied to a battery mounting structure according to a disclosed embodiment;

FIG. 9 is a view illustrating a rear mounting member of a strut assembly applied to a battery mounting structure according to a disclosed embodiment; and

FIGS. 10 to 13 are views for explaining an assembly process of a battery mounting structure according to a disclosed embodiment.

The drawings referenced above are not necessarily drawn to scale and are to be understood as presenting rather simplified representations of various preferred features that illustrate basic principles of the present disclosure. Certain design features of the present disclosure, including, for example, particular dimensions, directions, positions, and shapes will be determined in part by particular intended applications and use environments.

### DETAILED DESCRIPTION OF ILLUSTRATIVE EMBODIMENTS

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

The terminology used herein is for the purpose of describing particular embodiments only and is not intended to be limiting of the present disclosure. As used herein, singular forms are intended to include plural forms as well, unless the context clearly indicates otherwise.

As used herein, the term "comprises" and/or "comprising" refers to the presence of specified features, integers, steps, acts, elements, and/or components, but it should also be understood that it does not exclude a presence or an addition of one or more other features, integers, steps, acts, components, and/or groups thereof. As used herein, the term “and/or” includes any one or all combinations of one or more related items.

The term "coupled" denotes a physical relationship between two components in which components are directly connected to each other or indirectly connected through one or more intermediary components, for example, by welding, self-piercing rivets (SPR), flow drill screws (FDS), structural adhesives, and the like.

The terms “vehicle”, “of a vehicle”, “automobile”, or other similar terms used herein are generally used to cover various vehicles such as passenger vehicles including sports cars, sport utility vehicles (SUVs), buses, trucks, commercial vehicles, and the like, and cover hybrid vehicles, electric vehicles, hybrid electric vehicles, fuel cell electric vehicles, and other alternative fuel vehicles (i.e., vehicles driven by a fuel derived from resources other than petroleum).

Hereinafter, embodiments of the present invention will now be described in detail with reference to accompanying drawings.

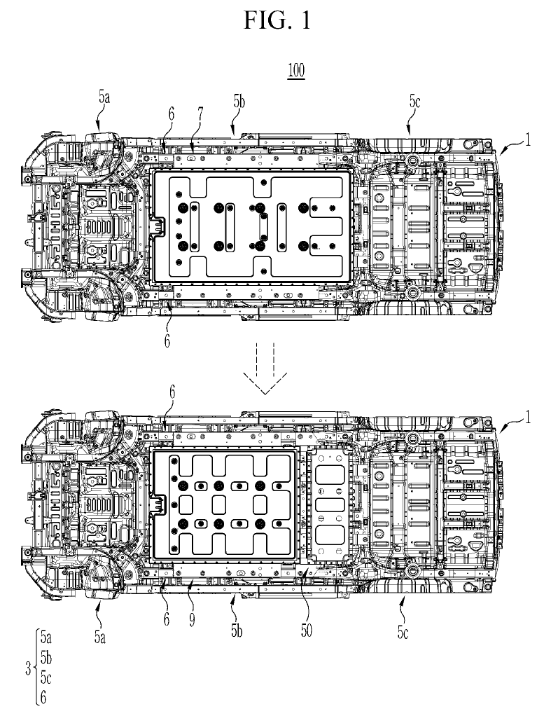

FIG. 1 is a bottom view of a body illustrating a battery mounting structure according to a disclosed embodiment.

Referring to FIG. 1, a battery mounting structure 100 according to the disclosed embodiment may be applied to, for example, a body 1 of a purpose built vehicle (hereinafter, referred to as 'PBV').

The PBV may be utilized as an electric vehicle-based life module vehicle that provides various customized services to users during the time it takes to move from the departure point to the destination.

In one example, the PBV may be manufactured to be designed in a one box type with a wide interior space. Furthermore, the PBV may also apply a facing type seat to the interior space. The body of such a PBV may be manufactured in various shapes and sizes depending on the intended use of the PBV.

Furthermore, the body 1 of the PBV may be utilized as various types of vehicles, for example, a hailing vehicle as a means of transporting passengers, a delivery vehicle for transporting goods, and a special vehicle such as an ambulance.

Here, the body 1 of the PBV may include an underbody 3 and an upper body (not shown) assembled to the underbody 3.

The underbody 3 may be provided as a floor structure of the vehicle body 1. The upper body may include a cabin placed in the front and rear when the body 1 of the PBV is used as a hailing type vehicle. In addition, the upper body may include a cabin positioned at the front and a cargo room positioned at the rear when the body 1 of the PBV is utilized as a delivery type (a cargo type or a chassis cab type).

In this specification, the reference direction for explaining the components below may be set as a front-rear direction of the body (e.g., a body length direction or a longitudinal direction), a width direction (e.g., a lateral direction or a left-right direction), and an up-down direction (e.g., a height direction) based on the body.

Furthermore, in embodiments of the present invention, a 'top portion', 'upper portion', 'top' or 'upper surface' of the component represents an end portion, portion, end, or surface of the component relatively above in the figure and a ‘bottom portion’, lower portion', ‘bottom', or ‘lower surface’ of the component. 'Lower ends', 'lower parts', 'bottom' or 'lower surface' represents, an end portion, portion, end, or surface relatively below in the figure.

Furthermore, in embodiments of the present invention, the end (e.g., one end or the other end) of the component represents the end of the component in a predetermined direction and the end portion (e.g., one end portion or the other end portion) of the component represents a predetermined portion of the component, which includes the end.

Meanwhile, the underbody 3 as described above may include an under front part 5a, an under center part 5b, and an under rear part 5c arranged along the front-rear direction of the vehicle body. Here, the under center part 5b may include under side parts 6 respectively arranged on both sides in the width direction.

Furthermore, battery assemblies 7 and 9 of different specifications may be mounted in the under center part 5b of the under body 3 of the body 1 of the PBV.

The battery assemblies 7 and 9 of the different specifications above may include battery cases of different sizes depending on the capacity of the battery cells mounted inside.

In the disclosed embodiment, the battery assemblies 7 and 9 of the different specifications may include, for example, a (first) battery assembly 7 of a first specification and a (second) battery assembly 9 of a second specification having a battery case of a relatively smaller size than the battery assembly 7 of the first specification.

That is, the battery assembly 7 of the first specification may include battery cells having a larger battery capacity than the battery assembly 9 of the second specification. And, the battery assembly 9 of the second specification may include battery cells having a smaller battery capacity than the battery assembly 7 of the first specification.

The battery mounting structure 100 according to the disclosed embodiment provides the structure capable of mounting the battery assemblies 7 and 9 of the different specifications on the basic vehicle body parts of the various vehicle models without structural changes to the underbody 3.

Here, the vehicle basic body parts of the various vehicle types can be defined as common parts of the underbody 3 that are not replaced even if the purpose of the use of the PBV and the specifications of the battery assemblies 7 and 9 are changed in the disclosed embodiments.

Furthermore, the battery mounting structure 100 according to the disclosed embodiment may provide a structure capable of reinforcing the torsional rigidity, etc. of the body 1 when the battery assembly 9 of the second specification is mounted on the underbody 3.

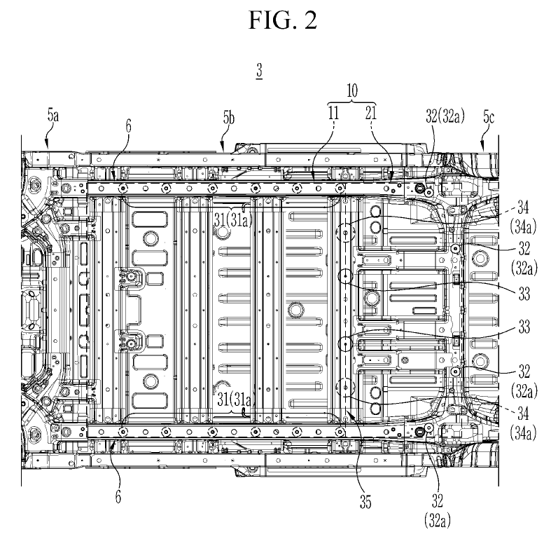

FIG. 2 is a bottom view of an underbody applied to a battery mounting structure according to a disclosed embodiment.

Referring to FIGS. 1 and 2, a battery mounting structure 100 according to the disclosed embodiment may include an integrated battery mounting section 10 and a strut assembly 50.

In the disclosed embodiment, the integrated battery mounting section 10 may be provided at a predetermined location of the underbody 3, for example, at the under center part 5b.

The above integrated battery mounting section 10 may include a battery mounting portion 11 and a dummy portion 21 partitioned along the front-rear direction of the vehicle body.

Here, the integrated battery mounting section 10 may be defined as an area combining the battery mounting portion 11 and the dummy portion 21.

The battery mounting portion 11 and the dummy portion 21 of the integrated battery mounting section 10 may be equipped with the battery assembly 7 of the first specification mentioned above. The battery mounting portion 11 may be equipped with the battery assembly 9 of the second specification mentioned above. Additionally, the dummy portion 21 may be equipped with a strut assembly 50 to be described later.

Furthermore, the battery mounting structure 100 according to the disclosed embodiment may include first mounting parts 31, second mounting parts 32, third mounting parts 33, and fourth mounting parts 34.

The mounting parts here are configured to be provided on the underbody 3, and may include a mounting bracket, mounting fastening parts, etc. for mounting related parts on the underbody 3. The configuration of such mounting parts is obvious to those skilled in the art, so a detailed description is omitted.

The first mounting parts 31 may be provided at the edge of the battery mounting portion 11. The second mounting parts 32 may be provided at the edge of the dummy portion 21. In addition, the third mounting parts 33 and the fourth mounting parts 34 can be provided at the boundary point 35 of the battery mounting portion 11 and the dummy portion 21.

In the above, the boundary point 35 is a connection point along the width direction of the battery mounting portion 11 and the dummy portion 21, and may include a transverse member of the underbody 3 (e.g., a floor cross member).

The battery assembly 7 of the first specification, which is placed in the battery mounting portion 11 and the dummy portion 21, may be mounted on the first mounting parts 31 and the second mounting parts 32. The battery assembly 9 of the second specification placed in the battery mounting portion 11 may be mounted on the first mounting parts 31 and the third mounting parts 33.

Here, the first mounting parts 31 may be provided as first common mounting parts 31a for mounting the battery assembly 7 of the first specification or the battery assembly 9 of the second specification.

A strut assembly 50 to be described later may be mounted on the second mounting parts 32. In addition, the battery assembly 9 of the second specification and the strut assembly 50 may be mounted on the fourth mounting parts 34. That is, the battery assembly 9 of the second specification and strut assembly 50 may be fastened to the fourth mounting parts 34.

Here, the second mounting parts 32 may be provided as second common mounting parts 32a for mounting a battery assembly 7 of the first specification or the strut assembly 50. In addition, the fourth mounting parts 34 may be provided as third common mounting parts 34a for fastening the battery assembly 9 of the second specification and the strut assembly 50.

In the disclosed embodiment, the strut assembly 50 is configured to reinforce the torsional rigidity, etc., of the underbody 3 when the battery assembly 9 of the second specification is mounted in the battery mounting portion 11 via the first mounting parts 31 and the third mounting parts 33.

The strut assembly 50 is provided separately and may be mounted on the dummy portion 21. The strut assembly 50 may be fixed to the second mounting parts 32 and the fourth mounting parts 34.

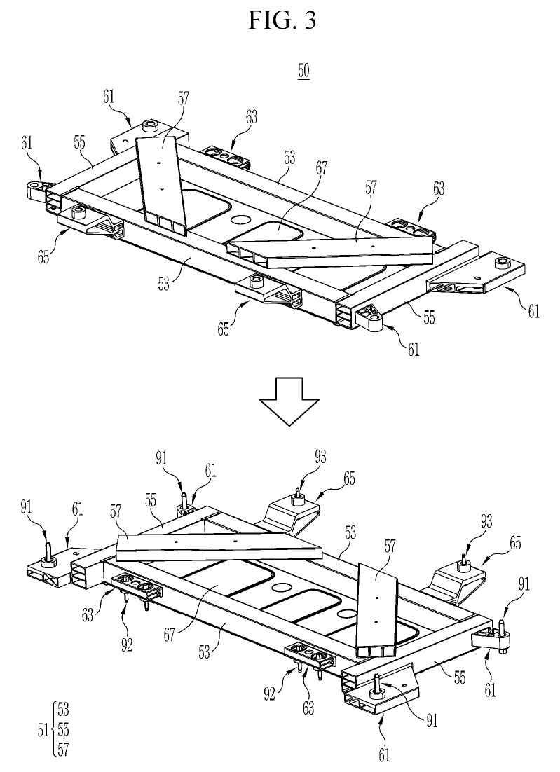

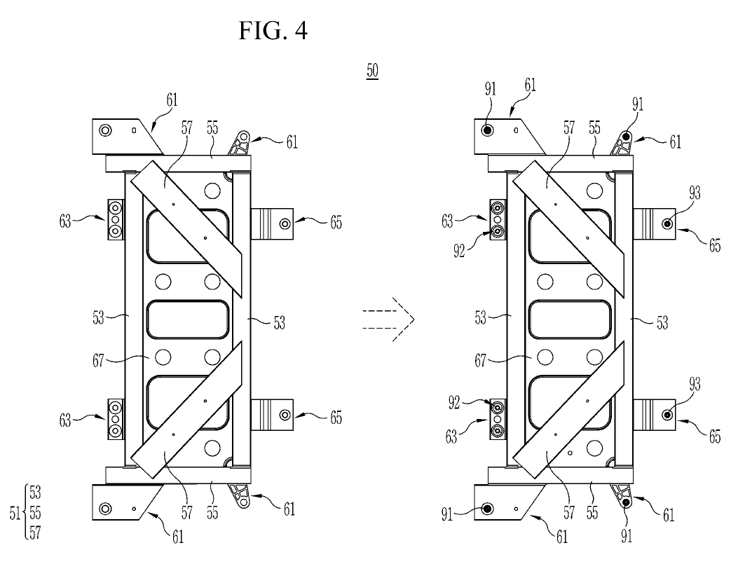

FIG. 3 is a perspective view illustrating a strut assembly applied to a battery mounting structure according to a disclosed embodiment, and FIG. 4 is a plan view illustrating a strut assembly applied to a battery mounting structure according to a disclosed embodiment.

Referring to FIGS. 1 to 4, the strut assembly 50 according to the disclosed embodiment may include a body support unit 51, at least one side mounting member 61, at least one battery mounting member 63, at least one rear mounting member 65, and an undercover 67.

A strut assembly 50 like this can be manufactured by a combination of a body support unit 51, at least one side mounting member 61, at least one battery mounting member 63, and at least one rear mounting member 65.

The body support unit 51 may be placed in the dummy portion 21. The body support unit 51 may include a pair of cross members 53, a pair of side members 55, and at least one diagonal reinforcing member 57.

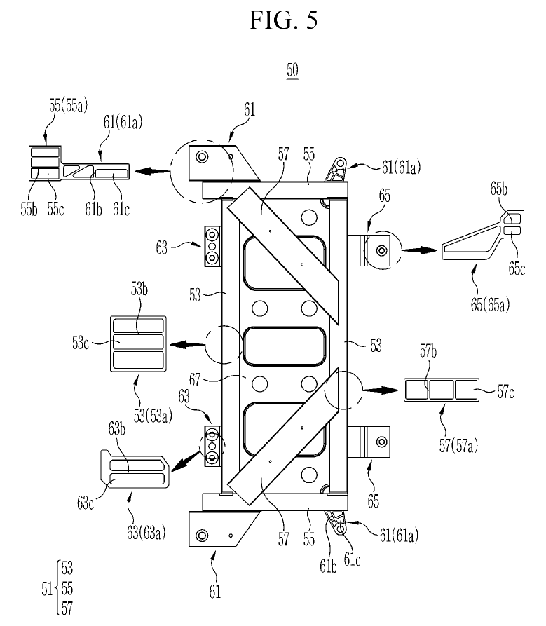

Here, the cross members 53, the side members 55, at least one diagonal reinforcing member 57, at least one side mounting member 61, at least one battery mounting member 63, and at least one rear mounting member 65 as described above may be provided as aluminum extrusion members 53a, 55a, 57a, 61a, 63a, and 65a, as illustrated in FIG. 5.

The aluminum extrusion members 53a, 55a, 57a, 61a, 63a, and 65a may be provided as aluminum extrusion materials formed by an aluminum extrusion method that is obvious to those skilled in the art.

The aluminum extrusion members 53a, 55a, 57a, 61a, 63a, and 65a may include closed sections 53c, 55c, 57c, 61c, 63c, and 65c formed internally by inner bulkheads 53b, 55b, 57b, 61b, 63b, and 65b.

These aluminum extrusion members 53a, 55a, 57a, 61a, 63a, and 65a may be joined by a welding. And, the aluminum extrusion members 53a, 55a, 57a, 61a, 63a, and 65a may be joined to each other through a mechanical joining method, for example, SPR or FDS, which is obvious to those skilled in the art.

Meanwhile, the cross members 53 may be arranged along the width direction of the dummy portion 21 and may be arranged spaced apart along the front-rear direction of the body.

The side members 55 may be joined to both ends of the cross members 53 along the front-rear direction of the vehicle body.

Also, at least one diagonal reinforcing member 57 may be diagonally connected to the cross members 53 and the side members 55. For example, at least one diagonal reinforcing member 57 may be provided as a pair.

The pair of diagonal reinforcing members 57 may be connected diagonally to the cross member 53 located at the rear at the connection point between the cross member 53 located at the front and the side members 55.

At least one side mounting member 61 may be configured to couple the body support unit 51 to the underside portion 6 of the underbody 3 in the dummy portion 21.

At least one of the side mounting members 61 may be connected to each of two sides of the body support unit 51 along the width direction. At least one of the side mounting members 61 may be coupled to side members 55 of the body support unit 51.

Also, at least one side mounting member 61 can be coupled (or mounted) to the underside portion 6. Here, at least one side mounting member 61 may be fastened to the second mounting parts 32 by a fastening member 91 composed of a combination of bolts and nuts.

These at least one side mounting members 61 may be provided as a pair, for example. The pair of side mounting members 61 may be coupled to the front and rear portions of the side members 55.

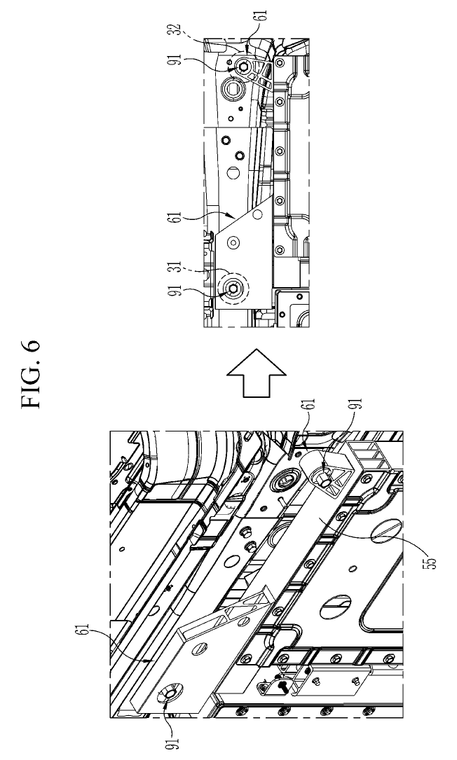

For example, as illustrated in FIG. 6, one of the side mounting members 61 positioned at the front among the pair of side mounting members 61 may be coupled to the first mounting member 31 positioned at the rearmost among the first mounting parts 31. Also, among the pair of side mounting members 61 above, another side mounting member 61 located at the rear may be coupled to the second mounting member 32 located at the rearmost position among the second mounting members 32.

At least one battery mounting member 63 is configured to connect the body support unit 51 to the boundary point 35 of the battery mounting portion 11 and the dummy portion 21.

In addition, at least one battery mounting member 63 is configured to fasten the body support unit 51 and the battery assembly 9 of the second specification mounted in the battery mounting portion 11 to the boundary point 35 between the battery mounting portion 11 and the dummy portion 21.

At least one battery mounting member 63 may be connected to the front portion of the body support unit 51. At least one battery mounting member 63 may be coupled to the cross member 53 disposed at the front of the body support unit 51.

At least one battery mounting member 63 may be fastened with the battery assembly 9 of the second specification mounted in the battery mounting portion 11.

Here, at least one battery mounting member 63 may be fastened to the fourth mounting parts 34 (referring to FIG. 2) together with the battery assembly 9 of the second specification at the boundary point 35 of the battery mounting portion 11 and the dummy portion 21.

At least one battery mounting member 63 may be provided as a pair, for example.

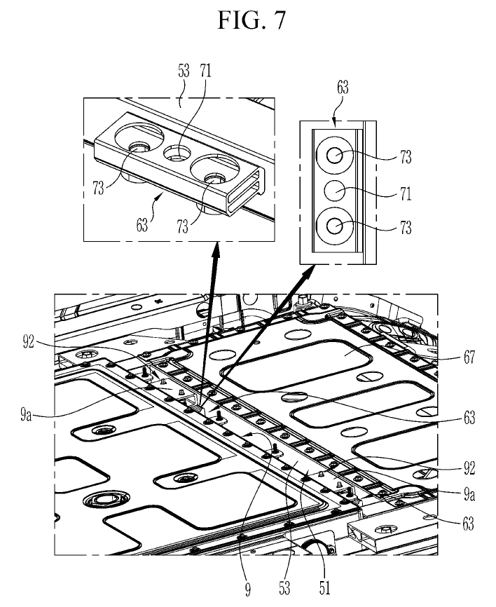

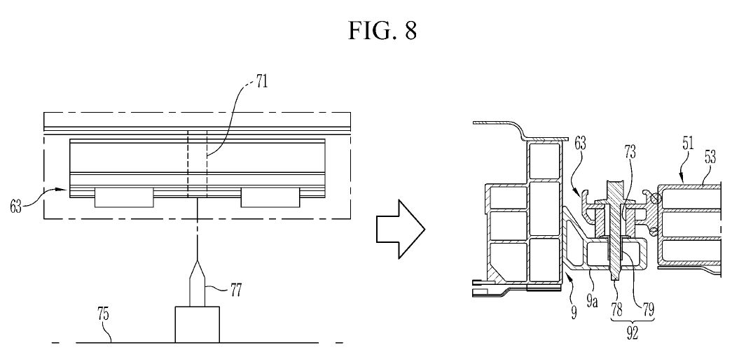

At least one of these battery mounting members 63 may include pin holes (71) and bolt fastening holes 73, as shown in FIGS. 7 and 8.

The pin hole 71 is designed so that the reference pin 77 provided on the battery mounting jig 75 is inserted in the up-down direction.

The bolt fastening holes 73 may be formed on both sides with the pin hole 71 in between.

At least one battery mounting member 63 may be fastened to the fourth mounting parts 34 (referring to FIG. 2) together with the battery assembly 9 of the second specification by a fastening member 92 composed of a combination of a bolt 78 and a nuts 79.

Here, the bolt 78 may be coupled to the bolt fastening holes 73. The nut 79 may be provided in the battery assembly 9 of the second specification and be fastened with the bolt 78. The nut 79 may be a weld nut fixed to the mounting flange 9a of the battery assembly 9 of the second specification.

At least one rear mounting member 65 is configured to couple the body support unit 51 to the under rear portion 5c of the under body 3 in the dummy portion 21.

At least one of the above rear mounting members 65 may be connected to the rear portion of the body support unit 51. At least one of the above rear mounting members 65 may be coupled to a cross member 53 arranged at the rear of the body support unit 51.

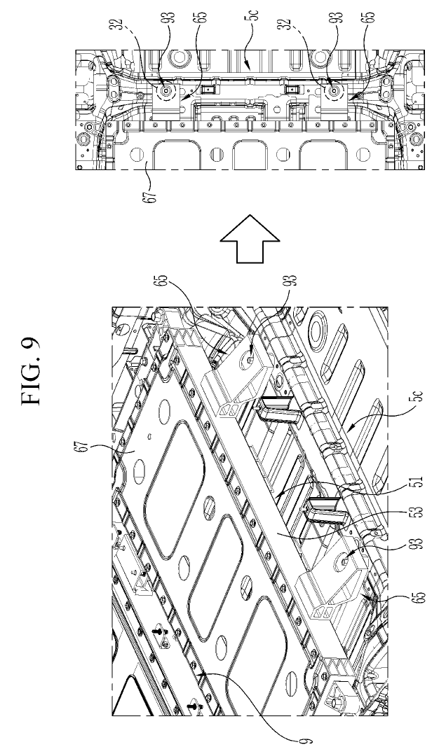

At least one rear mounting member 65 may be coupled (or mounted) to the under rear portion 5c of the under body 3, as shown in FIG. 9. Here, at least one rear mounting member 65 may be fastened to the second mounting parts 32 by a fastening member 93 composed of a combination of a bolt and a nut.

At least one rear mounting member 65 may be provided as a pair, for example.

Additionally, the undercover 67 is designed to cover the lower part of the body support unit 51. The undercover 67 may be coupled to the body support unit 51.

Here, the undercover 67 may be coupled to the lower portions of the cross members 53 and side members 55 of the body support unit 51. The undercover 67 may be fastened to the lower portions of the cross members 53 and the side members 55 by a fastening member (not shown) composed of a combination of a bolt and a nut.

Hereinafter, the assembly process and operation of the battery mounting structure 100 according to the disclosed embodiment configured as described above will be described in detail with reference to FIGS. 1 to 9 and the attached drawings.

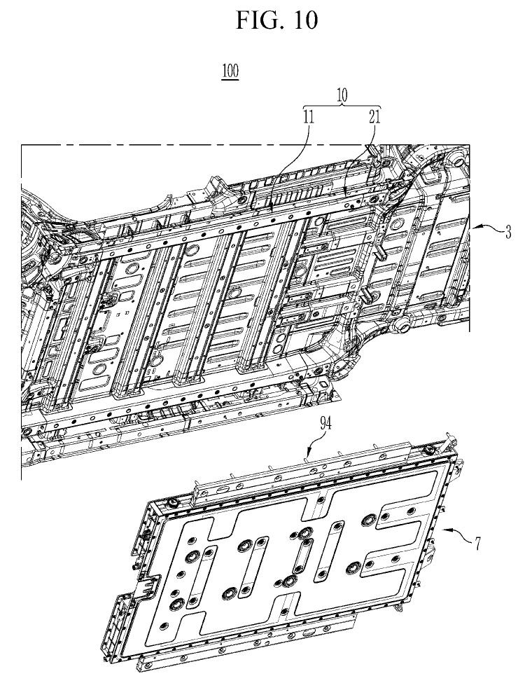

FIGS. 10 to 13 are views for explaining an assembly process of a battery mounting structure according to the disclosed embodiment.

First, in the disclosed embodiment, referring to FIGS. 1 to 9, in a process of assembling assembly components to a vehicle body 1, for example, in a battery assembly process, battery assemblies 7 and 9 of different specifications may be provided. The vehicle body 1 may include common parts of the underbody 3, which is a basic body part of various vehicle models.

In the disclosed embodiment, a strut assembly 50 may be provided including cross members 53 coupled to each other, side members 55, at least one diagonal reinforcing member 57, at least one side mounting member 61, at least one battery mounting member 63, at least one rear mounting member 65, and an undercover 67.

Here, the parts of the strut assembly 50 may be made of aluminum extrusions and be joined by various joining methods, for example, a welding.

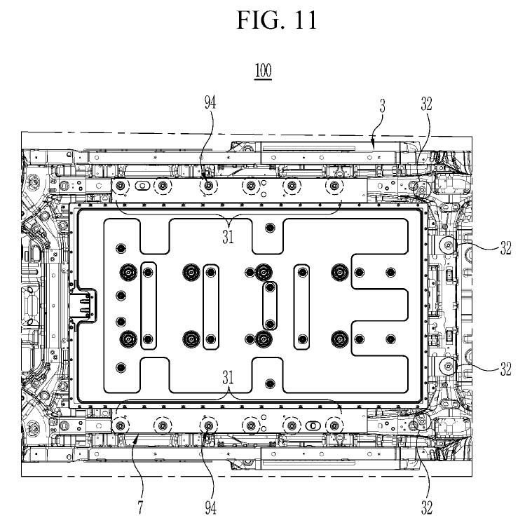

In this state, the process of mounting the battery assembly 7 of the first specification to the lower part of the underbody 3 may be performed, as shown in FIGS. 10 and 11.

In the above process, the battery assembly 7 of the first specification may be mounted on an integrated battery mounting section 10 including a battery mounting portion 11 and a dummy portion 21.

Here, the battery assembly 7 of the first specification may be mounted on the first mounting parts 31 and the second mounting parts 32 by a fastening member 94 composed of a combination of a bolt and a nut while being placed on the battery mounting portion 11 and the dummy portion 21.

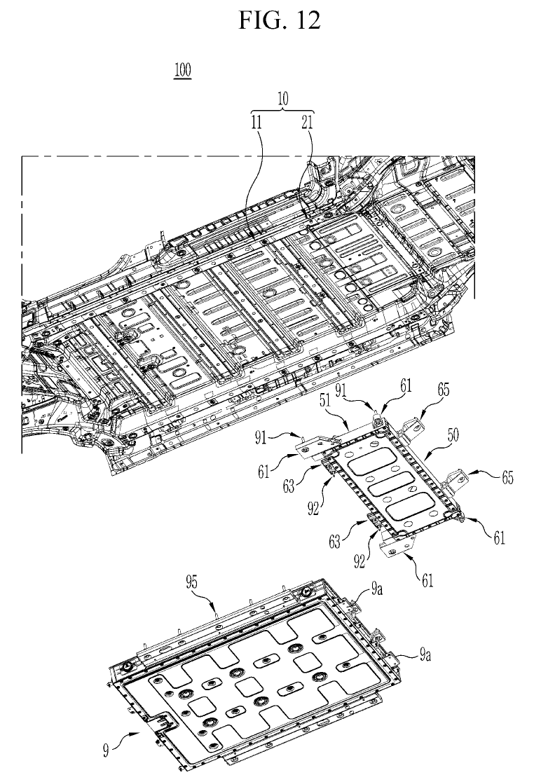

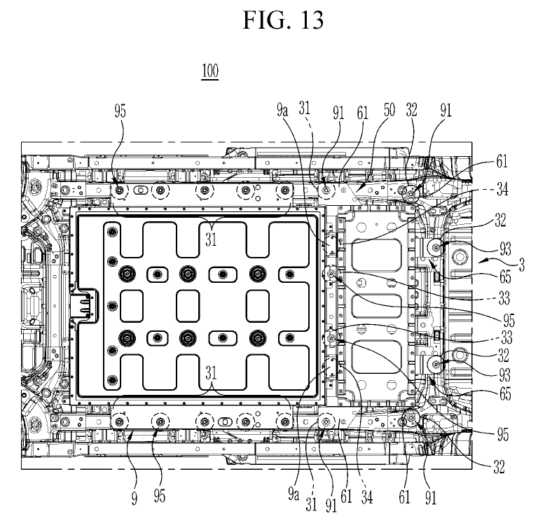

Meanwhile, in the disclosed embodiment, a process of mounting the strut assembly 50 and the battery assembly 9 of the second specification to the lower part of the underbody 3 may be performed, as shown in FIGS. 12 and 13. The battery assembly 9 of the second specification may include a battery case having a smaller size than the battery assembly 7 of the first specification (referring to FIG. 11).

In the above process, the strut assembly 50 may be placed in the dummy portion 21 of the underbody 3 by the battery mounting jig 75 (see FIG. 8).

At this time, the reference pin 77 provided on the battery mounting jig 75 may be fitted into a pin hole 71 formed in at least one battery mounting member 63. Accordingly, the strut assembly 50 may be correctly positioned in the dummy portion 21 by the battery mounting jig 75.

In this state, at least one side mounting member 61 may be fastened to the second mounting parts 32 by a fastening member 91. Also, at least one rear mounting member 65 may be fastened to the second mounting parts 32 by a fastening member 93.

Here, at least one battery mounting member 63 is located in the fourth mounting parts 34 (referring to FIG. 2) at the boundary point 35 between the battery mounting portion 11 and the dummy portion 21.

Then, the battery assembly 9 of the second specification may be placed in the battery mounting portion 11 by the battery mounting jig 75.

The battery assembly 9 of the second specification may be fastened to the first mounting parts 31 and the third mounting parts 33 by a fastening member 95 composed of a combination of bolts and nuts.

In the above process, the mounting flange 9a provided in the battery assembly 9 of the second specification is in a state of overlapping at least one battery mounting member 63 at the position corresponding to the fourth mounting parts 34.

In this state, the mounting flange 9a and at least one battery mounting member 63 may be fastened to the fourth mounting parts 34 by a fastening member 92 composed of a combination of a bolt 78 and a nut 79.

According to the battery mounting structure 100 assembled through the processes described above, the battery assemblies 7 and 9 of the different specifications may be mounted on the lower part of the underbody 3 depending on a purpose of a use and a use case of the PBV.

In addition, according to the battery mounting structure 100 according to the disclosed embodiment, the battery assemblies 7 and 9 with the battery cases of the different sizes depending on the battery capacity may be mounted on the lower part of the underbody 3.

For example, depending on the traveling driving performance of the PBV, etc., the battery assembly 7 of the first specification with the large battery capacity may be mounted on the integrated battery mounting section 10 of the underbody 3.

And, depending on the traveling driving performance of the PBV, etc., the battery assembly 9 of the second specification having a smaller battery capacity and battery case size than the battery assembly 7 of the first specification may be mounted in the battery mounting portion 11 of the integrated battery mounting section 10.

Furthermore, according to the battery mounting structure 100 according to the disclosed embodiment, when the battery assembly 9 of the second specification is mounted in the battery mounting portion 11, the strut assembly 50 may be mounted in the dummy portion 21 of the integrated battery mounting section 10.

Therefore, according to the battery mounting structure 100 according to the disclosed embodiment, the battery assemblies 7 and 9 of the different specifications may be mounted on the basic body parts of the various vehicle models without the structural changes to the underbody 3.

Accordingly, according to the battery mounting structure 100 according to the disclosed embodiment, the expandability of the body according to the traveling driving performance, the purpose of the use, and the use case of the PBV may be secured, and the platform performance of the underbody 3 may be secured.

In addition, according to the battery mounting structure 100 according to the disclosed embodiment, the battery assemblies 7 and 9 of the different specifications may be mounted on the basic body parts of the various vehicle types, so that a combined production according to the specifications of the body is possible, and a body development period and an investment cost may be reduced.

Furthermore, according to the battery mounting structure 100 according to the disclosed embodiment, by mounting the strut assembly 50 on the dummy portion 21, the lower rigidity and torsional rigidity of the body 1 may be strengthened.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A battery mounting structure comprising:
an integrated battery mounting section provided on an underbody of a vehicle body and comprising a battery mounting portion and a dummy portion partitioned along a front-rear direction of the vehicle body; and
a strut assembly mounted on the dummy portion.

2. The battery mounting structure of claim 1, further comprising
a first battery assembly of a first specification mounted in the integrated battery mounting section.

3. The battery mounting structure of claim 1, further comprising
a second battery assembly of a second specification having a smaller size than a first battery assembly of a first specification mounted in the integrated battery mounting section mounted in the battery mounting portion.

4. The battery mounting structure of claim 3, wherein
the strut assembly is fastened to the second battery assembly of the second specification mounted in the battery mounting portion.

5. The battery mounting structure of claim 1, further comprising:
a first mounting part provided on an edge of the battery mounting portion,
a second mounting part provided on the edge of the dummy portion, and
a third mounting part and a fourth mounting part provided at a boundary point of the battery mounting portion and the dummy portion.

6. The battery mounting structure of claim 5, wherein
a first battery assembly of a first specification is mounted on the first mounting part and the second mounting part.

7. The battery mounting structure of claim 5, wherein
a second battery assembly of a second specification having a smaller size than a battery assembly of a first specification mounted on the first mounting part and the second mounting part is mounted on the first mounting part and the third mounting part, and
wherein the first mounting part is a first common mounting part for mounting the battery assembly of the first specification or the battery assembly of the second specification.

8. The battery mounting structure of claim 7, wherein
the strut assembly is mounted on the second mounting part,
wherein the second battery assembly of the second specification and the strut assembly are mounted on the fourth mounting part, and
wherein the second mounting part is a second common mounting part for mounting the battery assembly of the first specification or the strut assembly.

9. The battery mounting structure of claim 1, wherein
the strut assembly comprises a plurality of aluminum extruded members having a plurality of closed sections comprising inner bulkheads.

10. The battery mounting structure of claim 1, wherein the strut assembly comprises:
a body support unit placed in the dummy portion,
at least one side mounting member connected each to sides of the body support unit in a vehicle width direction and combined with an under side part provided in the under body,
at least one battery mounting member connected to a front part of the body support unit and fastened to a second battery assembly of a second specification mounted in the battery mounting portion, and
at least one rear mounting member connected to a rear part of the body support unit and fastened with an under rear part provided in the under body.

11. The battery mounting structure of claim 10, wherein the body support unit further comprises:
a pair of cross members arranged along a width direction of the dummy portion, and
side members connected to ends of the cross members along the front-rear direction of the vehicle body.

12. The battery mounting structure of claim 11, wherein the body support unit further comprises:
at least one battery mounting member coupled to a cross member located at a front,
at least one rear mounting member coupled to a cross member located at a rear, and
at least one side mounting member coupled to the side members.

13. The battery mounting structure of claim 11, wherein the body support unit further comprises at least one diagonal reinforcing member diagonally connected to the cross member and the side member.

14. The battery mounting structure of claim 10, wherein the body support unit further comprises at least one battery mounting member comprising a pin hole into which a reference pin provided on a battery mounting jig is inserted and bolt fastening holes located on opposite sides of the pin hole.

15. The battery mounting structure of claim 10, further comprising:
a first mounting part provided on an edge of the above battery mounting portion,
a second mounting part provided on the edge of the dummy portion, and
a third mounting part and a fourth mounting part provided at a boundary point between the battery mounting portion and the dummy portion.

16. The battery mounting structure of claim 15, wherein a first battery assembly of a first specification is mounted on the first mounting part and the second mounting part.

17. The battery mounting structure of claim 15,
wherein the second battery assembly of the second specification having a smaller size than a first battery assembly of a first specification mounted on the first mounting part and the second mounting part is mounted on the first mounting part and the third mounting part, wherein the second mounting part is coupled with at least one side mounting member and at least one rear mounting member, and
wherein the second battery assembly of the second specification and at least one battery mounting member are coupled to the fourth mounting part.

18. The battery mounting structure of claim 10, wherein the strut assembly further comprises an undercover coupled to the body support unit.

19. A method for manufacturing a battery mounting structure, the method comprising:
providing an integrated battery mounting section on an underbody of a vehicle body, wherein the integrated battery mounting section comprises a battery mounting portion and a dummy portion partitioned along a front-rear direction of the vehicle body; and
mounting a strut assembly on the dummy portion.

20. A strut assembly comprising:
a body support unit comprising:
a pair of cross members spaced apart from each other along a first direction;
a pair of side members connected in a first direction to ends of the cross members;
at least one diagonal reinforcing member diagonally connected to at least one cross member and at least one side member;
at least one side mounting member connected to the at least one side member and configured to be mounted to a vehicle body;
at least one first mounting member connected to one of the cross members and configured to be fastened to a battery assembly; and
at least one second mounting member connected to another one of the cross members and configured to be mounted to the vehicle underbody.
